(19) United States
(12) Patent Application Publication
(10) Pub. No.: US 2018/0286246 A1
(43) Pub. Date: Oct. 4, 2018

(54) SENSOR-DERIVED ROAD HAZARD DETECTION AND REPORTING

(71) Applicant: Intel Corporation, Santa Clara, CA (US)

(72) Inventors: Jim S. Baca, Corrales, NM (US); Stephen Chadwick, Chandler, AZ (US); David Stanasolovich, Phoenix, AZ (US); Mark Price, Placitas, NM (US)

(21) Appl. No.: 15/475,462

(22) Filed: Mar. 31, 2017

(51) Int. Cl. G08G 1/16; B60R 21/0136; G01C 21/34; G06K 9/00; G06T 7/60

(52) U.S. Cl. CPC G08G 1/165; G08G 1/162; B60R 21/0136; B60R 2021/0027; G06K 9/00805; G06T 7/60; G01C 21/3453

(57) ABSTRACT

Systems and techniques for sensor-derived road hazard detection and reporting are described herein. Sensor data may be obtained from a sensor. The sensor may monitor a vehicle driven by a driver. A road hazard may be determined using the sensor data. A location of the road hazard may be identified. A message including the road hazard and he location of the road hazard may be transmitted for output on a display device of the vehicle.

### TECHNICAL FIELD

Embodiments described herein generally relate to road hazard detection and reporting and, in some embodiments, more specifically to sensor-derived road hazard detection and reporting.

### BACKGROUND

A road hazard may be an item that obstructs or otherwise interferes with vehicle traffic on a roadway. A road hazard may be caused by an item falling off or otherwise become detached from a vehicle on which the item was traveling. Road hazards may include potholes, pools of water, mud, rocks, etc. that may be in the roadway. Unsuspecting drivers may hit a road hazard which may cause the vehicle to go off the road, collide with another vehicle or other object, or may cause damage to the vehicle.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and system for sensor-derived road hazard detection and reporting, according to an embodiment.

FIG. 2 is a block diagram of an example of an environment and system for sensor-derived road hazard detection and reporting, according to an embodiment.

FIG. 3 is a block diagram of an example of a system for sensor-derived road hazard detection and reporting, according to an embodiment.

FIG. 4 is a flow diagram of an example process for sensor-derived road hazard detection and reporting, according to an embodiment.

FIG. 5 is an example of a user interface for sensor-derived road hazard detection and reporting, according to an embodiment.

FIG. 6 is an example of a user interface for sensor-derived road hazard detection and reporting, according to an embodiment.

FIG. 7 illustrates an example of a method for sensor-derived road hazard detection and reporting, according to an embodiment.

FIG. 8 is a block diagram illustrating an example of a machine upon which one or more embodiments may be implemented.

### DETAILED DESCRIPTION

In the United States, road debris is attributed to over 25,000 accidents and over 100 deaths. The top road debris item are blown pieces of tires. For example, a common occurrence is when a large 18 wheeler semi-truck blows out a tire while traveling at high rates of speed. This debris may be spewed across the highway leaving very large and dangerous chunks of hardened rubber. Other road hazards such as, for example, items that have fallen off vehicles, potholes, pooled water, animal carcasses, etc. may also pose a danger to approaching vehicles without advanced notice.

Currently, the process to identify and remove road hazards such as retreads may be performed manually. For example, a semi-truck and trailer may lose a retread (e.g., the outer surface of the tire) and the driver of the semi-truck may keeps on driving leaving the expelled retread on the road. A highway patrol person, department of transportation employee, or other person responsible for maintain the roadway may eventually remove the retread from the road. While the retread remains on the roadway it may cause damage to passing vehicles and/or collisions.

Pinpointing the source and location of dangerous road hazards and providing the information to approaching drivers may reduce collisions caused by road hazards. For example, sensors may be placed in the wheel well of a truck and/or trailer and may monitor tires to detect blowouts. Upon a blow-out, the sensor may detect, geo-tag, and transmit a message to the truck driver indicating that a tire blowout has occurred and where it occurred. GPS metadata may be updated for the location of the tire blowout indicating that debris in the form of a retread (e.g., tire debris) may be on the road. Thus, other drivers may be alerted to use caution while driving through the area corresponding with the tire blowout. If the truck driver leaves the debris on the road, the location of the tire debris may be communicated to personnel responsible for highway cleanup (e.g., highway department, transit authority, highway patrol, etc.). To cover the cost of this clean-up, the truck driver may be charged a fine for leaving tire debris. In another example, a dump truck may lose an item from the back of the dump truck (ex. gravel, lumber, metal, etc.). A sensor may detect that the item has fallen off of the truck, geo-tag the location where the item fell of the truck, communicate an alert to the driver of the dump truck, and update GPS metadata for the location, etc.

Immediately detecting the hazard that has been produced (e.g., retread or gravel or etc.), informing the driver, geo-tagging the location of the hazard, reporting it to other drivers via (IPS metadata updates, and informing the authorities is an improvement over traditional road hazard identification techniques because it may reduce the time the road hazard remains on the road (e.g., by notifying the driver and authorities, etc.) and reduce the number of unsuspecting vehicles that may interact with the road hazard (e.g., by notifying other drivers, etc.).

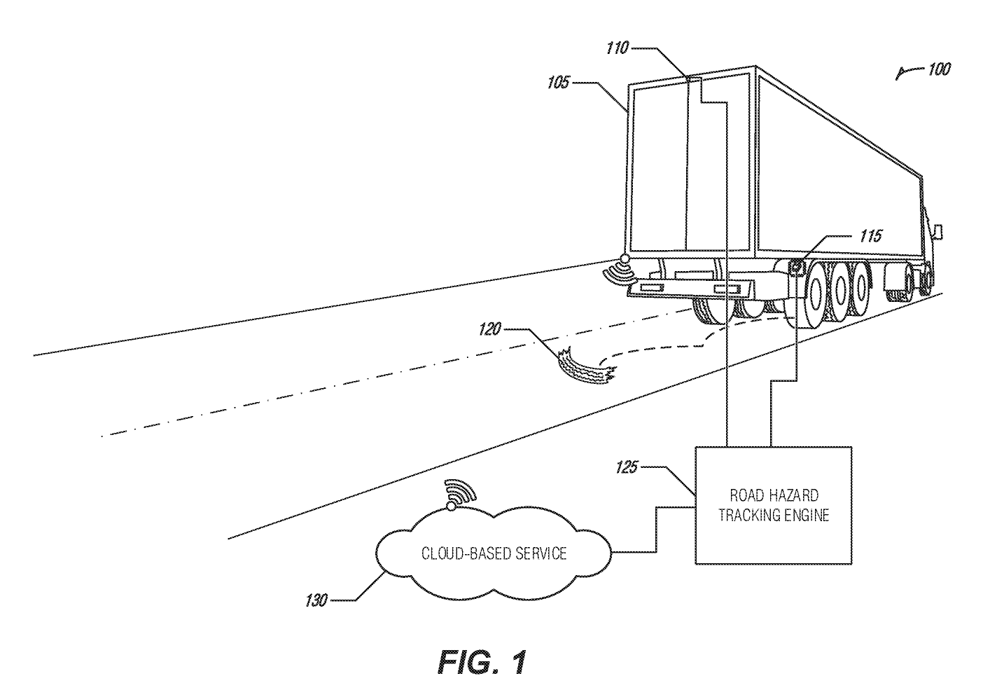

FIG. 1 is a block diagram of an example of an environment 100 and system for sensor-derived road hazard detection and reporting, according to an embodiment. The environment 100 may include a vehicle 105 including a variety of sensors including a camera 110 and a tire blowout sensor 115. The vehicle may have lost a retread 120. The camera 110 and the tire blowout sensor 115 may be communicatively coupled (e.g., via wireless network, wired network, near-field communication, shortwave radio, shared bus, etc.) to a road hazard tracking engine 125. The road hazard tracking engine 125 may be communicatively coupled to a cloud-based service 130 over a wireless network.

The vehicle 105 may be a car, truck, van, etc. The vehicle 105 may include an electronic navigation system including a global positioning system (GPS) receiver. The vehicle 105 may be traveling on a roadway and the GPS receiver may track the position of the vehicle it moves along the roadway. The vehicle 105 may include a variety of sensors for monitoring components of the vehicle 105. For example, sensors may monitor engine performance, drivetrain performance, etc. The sensors may be connected (e.g., using CAN bus, etc.) to an onboard computer that uses inputs received from the sensors to make adjustments to the components and or notify a driver of the vehicle 105 if an error is detected.

The sensors monitoring the vehicle 105 and its operating environment may include the camera 110 and the tire blowout sensor 115. The camera 110 may monitor the vehicle 105, the environment the vehicle 105 is operating in, and/or components of the vehicle 105 such as wheels, tires, mirrors, nuts, bolts, a carried load, etc. The tire blowout sensor 115 may be positioned in the wheel well of the vehicle and may monitor a tire of the vehicle 105. The tire blowout sensor 115 may use a variety of techniques for monitoring the tire. For example, the tire blowout sensor 115 may measure a distance between a surface of the tire and the sensor to determine tread depth and whether a retread (e.g., replacement tread surface of the tire) is in place. In another example, the tire blowout sensor 115 may receive a signal from a radio frequency identifier embedded in the tire (e.g., in a retread, etc.).

The road hazard tracking engine 125 may obtain data from the camera 110 and the tire blowout sensor 115. The data may be obtained directly from the camera 110 and the tire blowout sensor 115 and/or from the onboard computer of the vehicle 105. The data may include images, measurements, and other data that may be used to determine that the vehicle 105 has created a road hazard. For example, the vehicle 105 may be a semi-truck and trailer traveling on a roadway when the retread 120 is released from a wheel. Images from the camera 110 and/or sensor readings from the tire blowout sensor may be analyzed by the road hazard tracking engine 125 to determine that the retread 120 has been left on the roadway.

The road hazard tracking engine 125 may collect geolocation data from the GPS receiver in the vehicle 105 upon determining that the vehicle 105 has created road hazard. The geolocation data may be used to identify the location of the road hazard. The identified road hazard may be tagged with the geolocation data. For example, the retread 120 may be tagged with the longitude and latitude of the vehicle 105 at the time the road hazard was detected.

The road hazard tracking engine 125 may transmit (e.g., to a GPS display, driver notification display, infotainment display of the vehicle 105, etc.) an alert to the driver of the vehicle 105. The alert may include a description of the road hazard and the geolocation data of the road hazard. For example, the alert may indicate that the retread 120 was lost and the longitude and latitude of the retread 120. In some examples, the location of the road hazard may be displayed on a road map indicating a position along the roadway where the road hazard was created.

A selectable user interface element may be transmitted with the alert providing the driver to provide feedback regarding the status of the road hazard. In an example, a question asking whether the road hazard has been cleared may be presented along with yes and no buttons on a touchscreen display and the driver may select one of buttons to update the status of the road hazard. For example, the driver may not have noticed that the retread 120 was lost and may return to the location of the road hazard and after clearing the retread 120 from the roadway may select the yes button indicating the road hazard has been cleared.

The road hazard tracking engine 125 may transmit a description of the road hazard and location of the road hazard to the cloud-based service 130. The cloud-based service 130 may be a computer or a collection of computers used for distributing the road hazard description and corresponding location via a variety of transmission mediums (e.g., via cellular network, wireless network, microwave network, the internee. etc.). For example, the cloud-based service 130 may transmit the road hazard and road hazard location to a GPS receiver in the vehicle 105 and/or another vehicle via a cellular data network. In some examples, the road hazard information and location may be transmitted to a third-party service for delivery to a receiver in a vehicle.

The road hazard tracking engine 125 in conjunction with the cloud-based service 130 may transmit the road hazard description and corresponding location to another vehicle (e.g., a car approaching the location of the road hazard, etc.). The road hazard information may be transmitted to a display in the other vehicle (e.g., GPS display, infotainment system display, driver notification display, etc.) to alert the driver of the other vehicle that the road hazard may be present at the indicated location. The road hazard information may be transmitted to an authority responsible for maintaining the roadway. The authority may use the information to clear the road hazard.

For example, Jim may be travelling north on I-25 with his family in a new car. Everybody in the vehicle except Jim may be asleep due to the smooth drive and the duration of the ride. Jim may have a route set on a GPS unit and may keep checking the display on the GPS unit to see how much further in distance and time it is until they reach Denver. The vehicle 105 may be a couple of miles ahead of him and it may lose the retread 120. The driver of the vehicle 105 may be late for a delivery (or failed to notice the retread 120 was lost) so the driver of the vehicle 105 may continue driving leaving the retread 120 on the interstate.

The road hazard tracking engine 125 may use data received from the camera 110 and/or the tire blowout sensor 115 to detect that the retread 120 has been lost. The road hazard tracking engine 125 may transmit a notification to the driver of the vehicle 105 and authorities responsible for maintain the roadway. In some examples, a fine may be sent to the driver of the vehicle 105. The road hazard tracking engine 125 may geotag the location, driver info, date, time, and may update GPS metadata indicating a description of the road hazard and corresponding location. The road hazard tracking engine 125 may transmit the data to the cloud-based service 130 for distribution to Jim's car (e.g., via the GPS unit, etc.) and other vehicles in the vicinity of the road hazard.

Jim may look to see how much farther it is to Denver on his GPS unit and may notice a road hazard warning for the retread 120 that he may be approaching. He may slow the car (along with the other cars that received the road hazard information) and may know which lane to get in to avoid the road hazard. He may pass the retread 120 in the roadway. Thus, Jim was able to avoid colliding with the road hazard or another object because of the identification and notification of the road hazard.

Another vehicle may collide with the road hazard and/or another vehicle or object (e.g., tree, barrier, etc.) while trying to avoid the road hazard. The road hazard tracking engine 125 may identify that a collision has occurred by analyzing data received from another vehicle approaching the road hazard. For example, data from a collision detection system onboard the other vehicle may be received and the road hazard tracking engine 125 may identify (e.g., using images, sensor readings, etc.) that the other vehicle has collided with the road hazard or another object near the road hazard. The road hazard tracking engine 125 may collect information about the vehicle 105 and/or the driver of the vehicle 105, date and time the road hazard was created by the vehicle 105, location of the road hazard, etc. The information may be transmitted to an insurance party, owner of the other vehicle, authorities, etc. in response to identifying that the other vehicle has collided with the road hazard or another object near the road hazard.

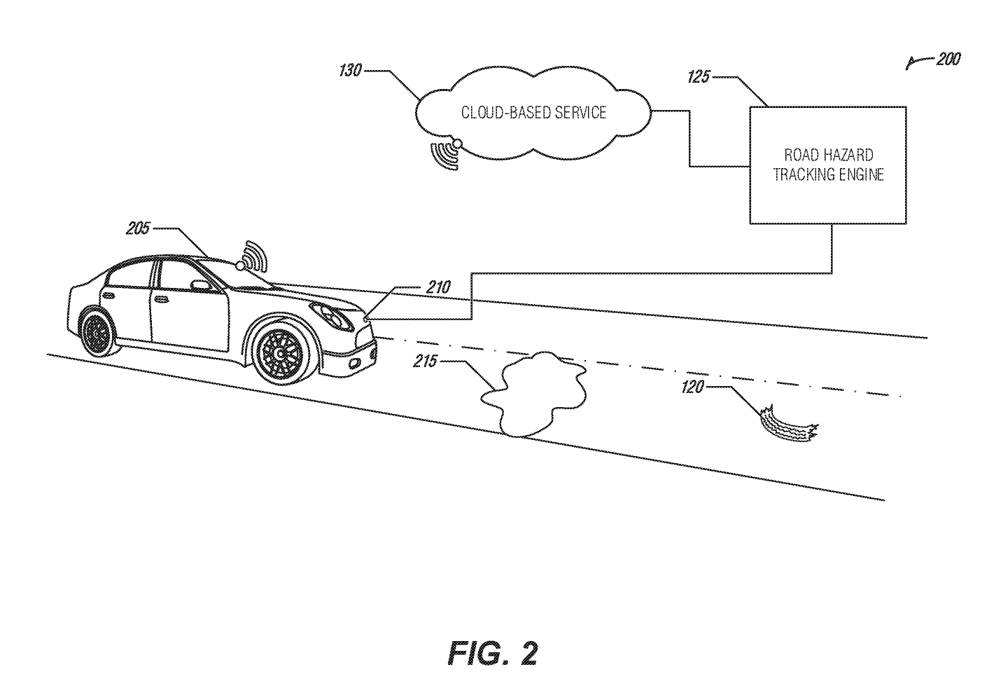

FIG. 2 is a block diagram of an example of an environment 200 and system for sensor-derived road hazard detection and reporting, according to an embodiment. The environment 200 may include a vehicle 205 including a variety of sensors such as a camera 210. The camera 210 may be communicatively coupled to a road hazard tracking engine 125. The road hazard tracking engine 125 may be communicatively coupled to a cloud-based service 130. The vehicle 205 may be approaching a road hazard such as retread 120.

The road hazard tracking engine 125 may have determined that a road hazard has been created by the retread 120. The road hazard tracking engine 125 may send a notification including a description and location of the road hazard to the vehicle 205 via the cloud-based service 130 (e.g., using cellular data services, etc.). The notification may be displayed on a display of the vehicle 205 such as, for example, a GPS unit, a driver information display, a heads-up display, etc.

The road hazard tracking engine 125 may obtain images from the camera 210 and may use the images to identify road hazards and/or identify that road hazards have been cleared. In an example, the retread 120 may no longer be at the location included in the notification received and images from the camera may be analyzed (e.g., using object recognition, etc.) by the road hazard tracking engine 125 to identify that the road hazard created by the retread 120 has been cleared. Alternatively or additionally, the road hazard tracking engine 12.5 may transmit a user interface to a display in the vehicle 205 including a message asking if the road hazard has been cleared and one or more selectable user interface elements for receiving a response from a driver of the vehicle 205 indicating whether (or not) the road hazard caused by the retread 120 has been cleared.

The road hazard tracking engine 125 may analyze images obtained from the camera 210 and other sensors included with the vehicle 205 to identify a road hazard. For example, an image of roadway may include water pool 215 and the image may be analyzed (e.g., using object recognition, etc.) to identify the water pool 215 as a road hazard. The road hazard tracking engine 125 may capture the time, date, location (e.g., using a GPS receiver, etc.), and other information and may geotag the water pool 215 with the information. The road hazard tracking engine 125 may transmit the information to other vehicles, the authorities, etc. via the cloud-based service 130.

For example, Sherry may be driving on I205 in Oregon on her way to the airport. Four miles ahead, a driver of another vehicle may blow a tire and may be pulled over onto the side of the highway. The driver of the other vehicle may begin setting up to put on a spare tire. The other vehicle may have tire sensors and may be communicatively coupled to the road hazard tracking engine 125 and the road hazard tracking engine 125 may identify the blowout as a road hazard and may communicate a notification including the blowout and the location of the blowout to GPS units within a specified region (e.g., in the vicinity of the road hazard, etc.). The road hazard tracking engine 125 may geotag the location of the blowout with a hazard warning that shows on a GPS display and/or compatible auto communications systems. Seeing the hazard warning for the blowout while she is three miles away, Sherry may change lanes to stay clear of the other vehicle on the side of the road.

For example, Jim may be driving the vehicle 205 after heavy rain on I5 and may approach the water pool 215 reaching into the outer lane of the roadway. Jim may swerve in response and may almost collide with another car in a passing lane. The road hazard tracking engine 125 may detect the swerve using measurements received from a collision avoidance sensor in the vehicle 205, a high water level using sensor measurements received from water sensors in the wheel wells of the vehicle 205, and the water pool 215 using images obtained from the camera 210. The road hazard tracking engine 125 may determine that the water pool 215 is a road hazard based on the sensor data and the water pool 215 may be geotagged and a hazard warning may be communicated to the GPS display and other compatible auto communications systems of vehicles in the vicinity of the water pool 215. Sherry's GPS and auto communication system may receive the warning and, as a result, she may change lanes away from the water pool 215 while she is still two miles away.

In an example, the vehicle 205 may be an autonomous vehicle and the notification may be transmitted to a navigation and routing system of the vehicle 205. The notification may cause the navigation and routing system to reroute the vehicle 205 to avoid the retread 120 or other road hazards indicated in notifications transmitted by the road hazard tracking engine 125. For example, the retread 120 may be interfering with the lane on a first roadway and the navigation and routing system of the vehicle 205 may recalculate the route being traveled by the vehicle to a second roadway to avoid the road hazard.

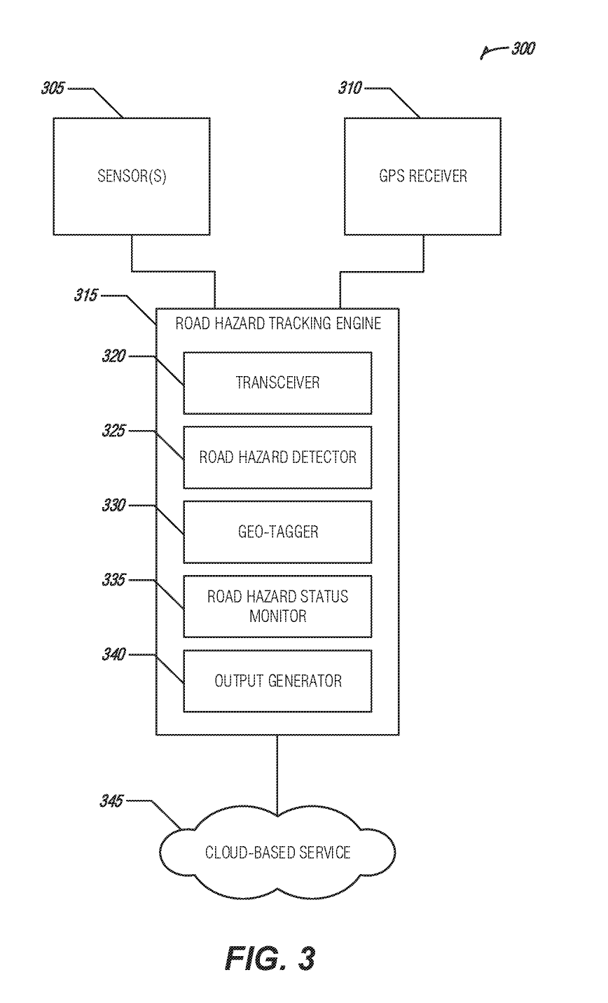

FIG. 3 is a block diagram of an example of a system 300 for sensor-derived road hazard detection and reporting, according to an embodiment. The system 300 may provide functionality as described in FIGS. 1 and 2. The system 300 may include a variety of components including sensor(s) 305, a GPS receiver 310, a road hazard tracking engine 315, and a cloud-based service 345. The road hazard tracking system 315 may include a transceiver 320, a road hazard detector 325, a geo-tagger 330, a road hazard status monitor 335, and an output generator 340. The sensor(s) 305 and the GPS receiver 310 may be communicatively coupled (e.g., via wired network, wireless network, near-field communication, shortwave radio, shared bus, etc.) to the road hazard tracking engine 315. The road hazard tracking engine 315 may be communicatively coupled (e.g., via wired network, wireless network, near-field communication, shortwave radio, shared bus, etc.) to the cloud-based service 345.

The sensor(s) 305 may include a variety of sensors for monitoring the operation and/or environment in which a vehicle (e.g., vehicle 105 as described in FIG. 1, vehicle 205 as described in FIG. 2, etc.) may be operating. The sensor(s) 305 may include, but are not limited to, tire pressure sensors, tire blowout sensors, cameras, water sensors, collision sensors, traction control sensors, speed sensors, brake sensors, scales, radio frequency identification receivers, a vehicle computer, etc. For example, a tire blowout sensor may be positioned in a wheel well of a vehicle to monitor the status of a tire. The sensor(s) 305 may collect data and transmit the collected data to the road hazard tracking 315.The GPS receiver 310 may collect location information as the vehicle travels along a roadway. The GPS receiver 310 may output location data to the road hazard tracking engine 315.

The road hazard tracking engine 315 may identify, geo-tag, and monitor road hazards caused and/or identified by the vehicle. The road hazard tracking engine 315 may receive data from the sensor(s) 305 and the GPS receiver via the transceiver 320. The transceiver 320 may be responsible for receiving and processing inputs received from the sensor(s) 305 and the GPS receiver 310. The transceiver 320 may obtain sensor data from the sensor(s) 305. The sensor(s) 305 may be monitoring a vehicle driven by a driver. The transceiver 320 may route the inputs to other components of the road hazard tracking engine 315 based on the type of input received. The transceiver 320 may receive requests from other components of the road hazard tracking engine 315 to collect data from the sensor(s) 305 and/or the GPS receiver 310. The transceiver 320 may process outputs generated by the road hazard tracking engine 315 such as, for example, the output generator 340. For example, the transceiver 320 may transmit messages generated by the output generator 340 to the cloud-based service 345.

The road hazard detector 325 may determine a road hazard using the sensor data received via the transceiver 320. In an example, a first image may be obtained including an item traveling with the vehicle from the sensor data. For example, an image may be received from a camera included in the sensor(s) 305 including a board loaded in a cargo area of a truck. A second image of an area around the vehicle may be obtained from the sensor(s) 305. For example, an image of the roadway behind the truck may be obtained from the camera included in the sensor(s) 305. The second image may be analyzed to determine that the item (e.g., board) is no longer traveling with the vehicle and the road hazard may be determined based on the determination that the item is no longer traveling with the vehicle. For example, the board may be identified in the image of the roadway behind the truck indicating that the board is no longer in the cargo area of the truck and has now become a road hazard as it is identified in the roadway behind the truck.

In an example, a measurement may be obtained between an object traveling with the vehicle and the sensor(s) 305 from the sensor data. For example, a distance measurement may be obtained between a tire of the vehicle and a depth sensor included in the sensor(s) 305. The road hazard detector may determine that the measurement between the object traveling with the vehicle and the sensor(s) 305 has changed using the sensor data. For example, the average distance between the depth sensor and the tire may have increased by half an inch. The road hazard may be determined based on the determination that the measurement between the object traveling with the vehicle and the sensor(s) 305 has changed. For example, the increase of half an inch distance between the depth sensor and the tire may indicate that the tire has lost a retread and the retread may be determined to be a road hazard.

In an example, the road hazard detector 325 may identify a presence of a radio frequency identifier (RFID) corresponding to an item traveling with the vehicle using the sensor data. For example, a refrigerator may be traveling in a cargo area of a truck and may have an RFID tag affixed and an RFID receiver included in the sensor(s) 305 may identify the presence of the RFID tag affixed to the refrigerator. It may be determined that the presence of the RFID corresponding to the item no longer exists and the road hazard may be determined based on the determination that the presence of the RFID no longer exists. For example, a signal may no longer be received from RFID tag affixed to the refrigerator and it may be determined that the refrigerator has left the cargo area and may be determined to be a road hazard.

In an example, an image may be obtained from the sensor data. The image may include a pavement surface. For example, a camera included in the sensor(s) 305 may capture an image of the roadway in front of the vehicle. A presence of a foreign object may be identified on the pavement surface by analyzing the image. In an example, the road hazard detector 325 may analyze the image using object recognition to identify the foreign object in the image. The road hazard may be determined based on the presence of the foreign object on the pavement surface. For example, water may be pooled on the roadway and the image of the pavement surface may be analyzed to identify the pavement surface and determine that the pooled water is a road hazard. The geotagging information may include a variety of data items such as, for example, time, date, location, identity of driver and/or vehicle causing and/or identifying the road hazard, etc.

The geo-tagger 330 may identify a location of the road hazard. The geo-tagger 330 may receive location data from the GPS receiver 310 via the transceiver 320. The location data may include longitude, latitude, time, date, etc. In an example, a time of detection of the road hazard may be identified. Geolocation data may be obtained for the vehicle at the time of detection using the GPS receiver. The geo-tagger 330 may geotag the road hazard using the geolocation data.

The output generator 340 may transmit a message including the road hazard and location of the road hazard for output to the driver on a display device (e.g., a display of a GPS unit, a display of a driver information system, a heads-up display, etc.). The output generated by the output generator may include a description of the road hazard (e.g., retread, water pool, pothole, etc.) and a location of the road hazard (e.g., right lane, middle of the right lane, left lane, etc.). The output generator 340 may work in conjunction with the transceiver 320 to transmit the road hazard information to a variety of end points such as the cloud-based service 345. The cloud-based service 345 may be a collection of computing devices capable of transmitting information via a variety of communication channels (e.g., via cellular data, the internet, satellite broadcast, etc.).

Messages generated by the output generator 340 may be transmitted to the driver of a vehicle causing the road hazard, other vehicles approaching the road hazard, authorities responsible for maintaining the roadway, etc. In an example, the message includes the road hazard and location of the road hazard may be transmitted to an authority responsible for the location of the road hazard. In an example, a fine may be issued to the driver of the vehicle causing the road hazard.

In an example, a message including the road hazard and the location of the road hazard may be transmitted to the cloud-based service 345. The message including the road hazard and the location of the road hazard may be output to a subscriber of the cloud-based service 345. For example, a person may subscribe to the cloud-based service 345 to obtain road hazard information via a GPS unit installed in the person's vehicle and the message may be transmitted from the cloud-based service 345 to the GPS unit to display the road hazard and location of the road hazard on a map display of the GPS unit.

The road hazard status monitor 335 may monitor the geotagged road hazard to determine whether the road hazard has been cleared and/or if the road hazard has caused a collision. In an example, an image of the location of the road hazard may be obtained (e.g., by the transceiver 320) by the road hazard status monitor 335 from a camera included in a vehicle of a subscriber to the cloud-based service 345. The road hazard status monitor 335 may identify that the road hazard no longer exists at the location of the road hazard using the image (e.g., using object recognition, etc.). The road hazard status monitor 335 may tag the road hazard as cleared based on the identification that the road hazard no longer exists at the location of the road hazard. The tagging may prevent the message including the road hazard and the location of the road hazard from being output to other subscribers of the cloud-based service 345. For example, a retread may no longer be located in the middle lane of traffic and the output generator 340 may generate output instructing the cloud-based service 345 to discontinue sending the road hazard information to subscribers approaching the location of the road hazard.

In an example, the road hazard status monitor 335 may work in conjunction with the output generator 340 to generate the message for presentation to the driver in a user interface. A selectable user interface element may be displayed in the user interface that when selected indicates the road hazard has been cleared. Upon receiving selection of the selectable user interface element, the road hazard status monitor may tag the road hazard as cleared. The road hazard status monitor 335 may work in conjunction with the output generator 340, transceiver 320, and the cloud-based service 345 to prevent further transmission of messages regarding the road hazard.

In an example, the road hazard status monitor 335 may identify that a collision has occurred near the location of the road hazard using data collected from a sensor array included with a vehicle of the subscriber of the cloud-based service 345. For example, collision detection sensor data may be transmitted to the road hazard status monitor 335 via the cloud-based service 345 and the transceiver 320 and the data may be analyzed to determine that the vehicle of the subscriber collided with the road hazard. The road hazard status monitor 335 may obtain information about the driver of the vehicle causing the road hazard and the information about the driver, the road hazard, and the location of the road hazard may be transmitted to a third party. For example, a message indicating that the subscriber's vehicle collided with a retread in the center lane of the roadway and information such as the driver's name, driver's license number, insurance information, etc. may be transmitted to the subscriber's insurance company.

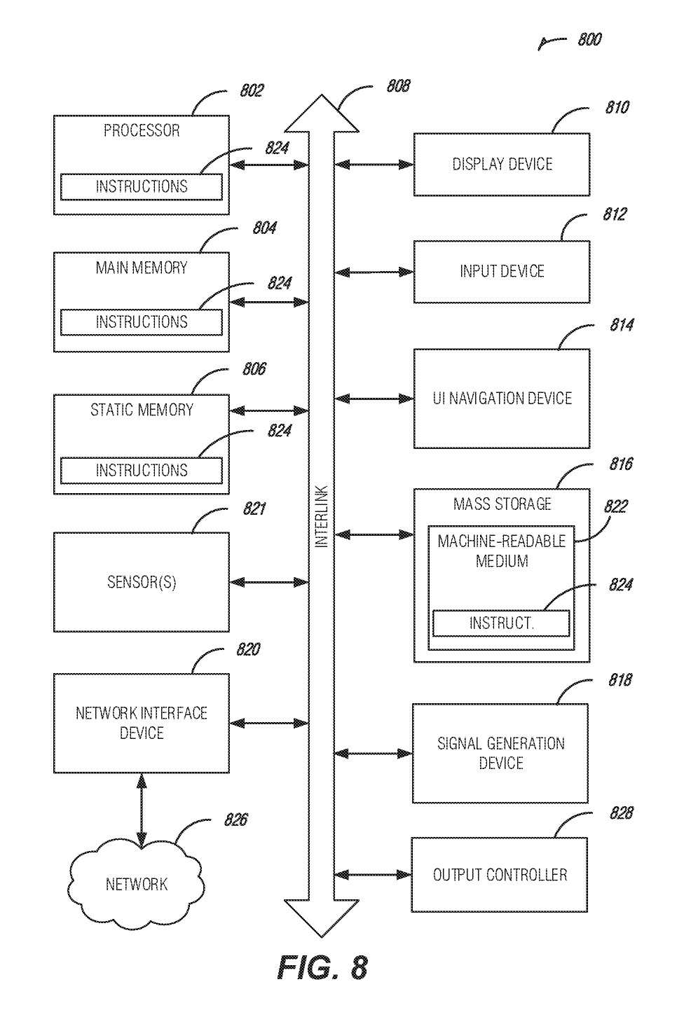

The present subject matter may be implemented in various configurations. For example, the transceiver 320, the road hazard detector 325, the geo-tagger 330, the road hazard status monitor 335, and the output generator 340 may be implemented in different (or the same) computing systems (e.g., a single server, a collection of servers, a cloud-based computing platform, etc.). A computing system may comprise one or more processors (e.g., hardware processor 802 described in FIG. 8, etc.) that execute software instructions, such as those used to define a software or computer program, stored in a computer-readable storage medium such as a memory device (e.g., a main memory 804 and a static memory 806 as described in FIG. 8, a Flash memory, random access memory (RAM), or any other type of volatile or non-volatile memory that stores instructions), or a storage device (e.g., a disk drive, or an optical drive). Alternatively or additionally, the computing system may comprise dedicated hardware, such as one or more integrated circuits, one or more Application Specific Integrated Circuits (ASICs), one or more Application Specific Special Processors (ASSPs), one or more Field Programmable Gate Arrays (FPGAs), or any combination of the foregoing examples of dedicated hardware, for performing the techniques described in this disclosure.

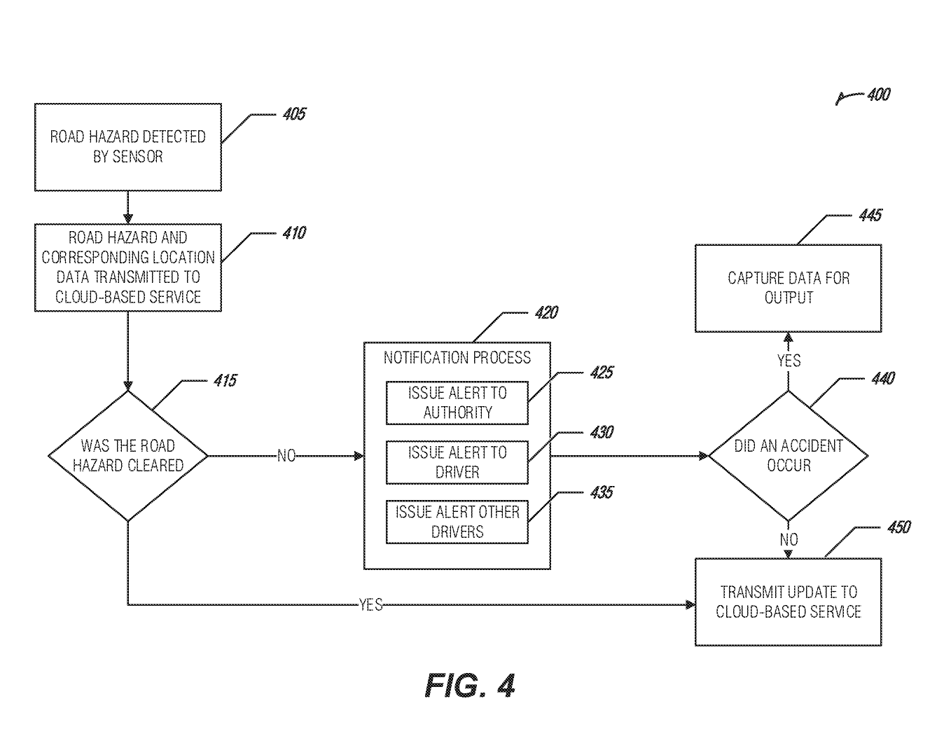

FIG. 4 is a flow diagram of an example process 400 for sensor-derived road hazard detection and reporting, according to an embodiment. The process 400 may provide functionality as described in FIGS. 1, 2, and 3.

At operation 405, a road hazard may detected by a sensor (e.g. by the road hazard detector 325 as described in FIG. 3).

At operation 410, the road hazard and corresponding location data (e.g., as indicated by geo-tagger 330 as described in FIG. 3) may be transmitted (e.g., via transceiver 320 as described in FIG. 3) to a cloud-based service (e.g., cloud-based service 345 as described in FIG. 3)

At decision 415, it may determine by the road hazard status monitor 335 as described in FIG. 3) if the road hazard has been cleared. If it is determined that the road hazard has been cleared, the process 400 continues at operation 450. If it has been determined that the road hazard has not been cleared, the process 400 continues to operation 420.

At operation 420, a notification including the road hazard, location of the road hazard, etc. may be generated (e.g., by the output generator 340 as described in FIG. 3) and transmitted (e.g., using the transceiver 320 and/or cloud-based service 345 as described in FIG. 3).

At operation 425, an alert including the notification may be transmitted to an authority responsible for the roadway (e.g., law enforcement, maintenance, etc.).

At operation 430, an alert including the notification may be transmitted to a driver of a vehicle causing the road hazard (e.g., a vehicle including the sensor from operation 406, etc.).

At operation 435, an alert including the notification may be transmitted to other drivers (e.g., to drivers and/or vehicles approaching the road hazard, etc.).

At decision 440, it may be determined (e.g., by the road hazard status monitor 335 as described in FIG. 3) if an accident has occurred. If it is determined that an accident has not occurred the process 400 continues to operation 450. In an example, rather than continuing to operation 450, the process 400 may return to decision 415 and continue tracking the road hazard to determine if the road hazard has been cleared. If it is determined that an accident has occurred, the process 400 continues to operation 445.

At operation 445, data may be captured (e.g., by the road hazard status monitor 335 as described in FIG. 3) for output (e,g., by the output generator 340 using the transceiver 320 and/or cloud-based service 345 as described in FIG. 3).

At operation 450, an update (e.g., output indicating that notifications should be suspended, etc.) may be transmitted to the cloud-based service (e.g., cloud-based service 345 as described in FIG. 3).

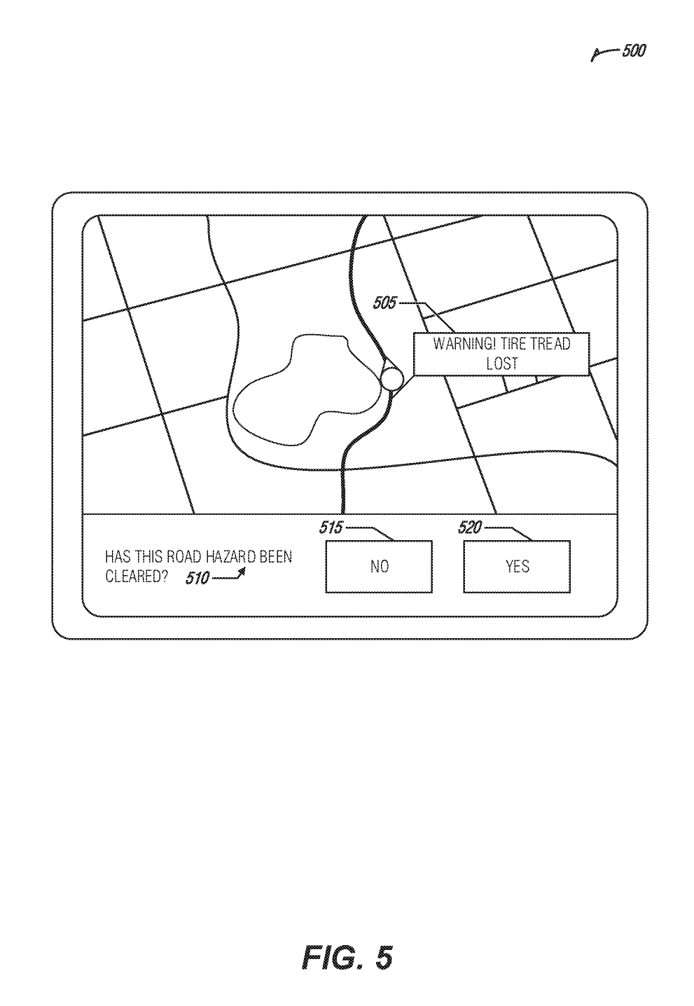

FIG. 5 is an example of a user interface 500 for sensor-derived road hazard detection and reporting, according to an embodiment. The user interface 500 may be used to display output and provide input as described in FIGS. 1, 2, and 3. The user interface 500 may be a GPS interface including a map displayed on a device in a vehicle. A warning 505 may be displayed on the map at a location indicated in road hazard data received by the device displaying the user interface 500. For example, the device may be a GPS unit and the road hazard data may be received from a cloud-based service (e.g., cloud-based service 345 as described in FIG. 3) via a cellular data network. The warning 505 may include a description of the road hazard that has been created (e.g., tire tread lost from a truck including the device, etc.). A driver of the vehicle may be presented with a prompt 510 including selectable user interface elements such as no button 515 and yes button 520. The driver of the vehicle (e.g., user) may stop the vehicle to confirm whether or not a road hazard has been created and/or to remove a road hazard from the roadway. The driver may select the no button 515 and the road hazard information may be collected and transmitted (e.g., as described in FIG. 3) or the yes button 520 and the road hazard information may not be transmitted (or the transmission may be modified, etc.)

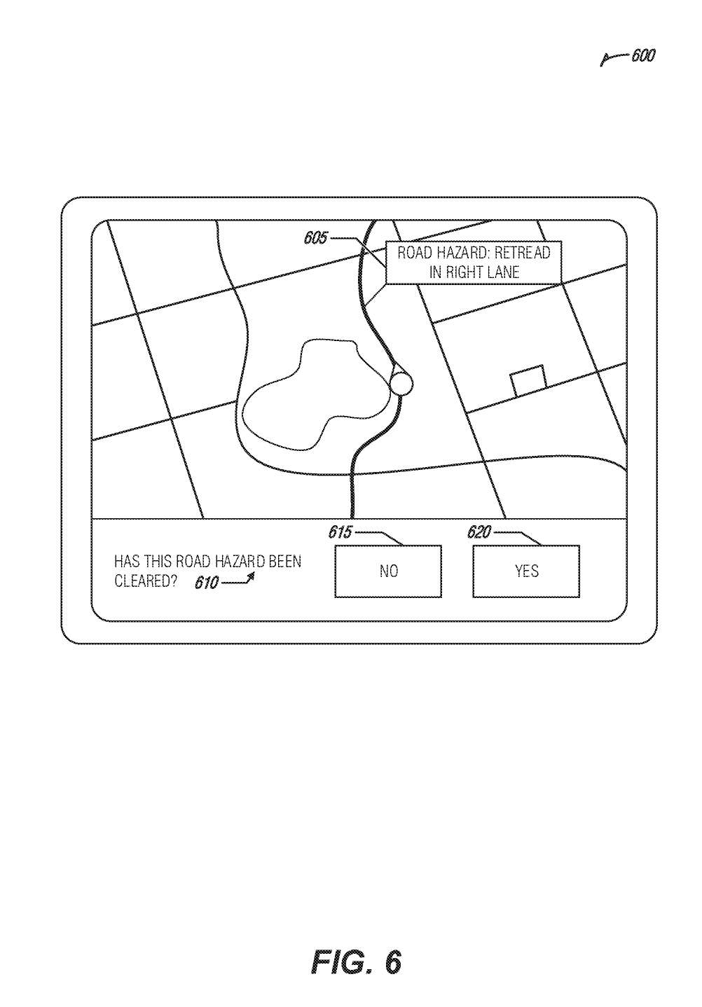

FIG. 6 is an example of a user interface 600 for sensor-derived road hazard detection and reporting, according to an embodiment. The user interface 600 may be used to display output and provide input as described in FIGS. 1, 2, and 3. The user interface 600 may be a GPS interface including a map displayed on a device in a vehicle. A road hazard notification 605 may be displayed on the map at a location indicated in road hazard data received by the device displaying the user interface 600. For example, the device may be a GPS unit and the road hazard data may be received from a cloud-based service (e.g., cloud-based service 345 as described in FIG. 3) via a cellular data network. The road hazard notification 605 may include a description of the road hazard (e.g., tire retread lost from a truck, etc.). A driver of the vehicle may be presented with a prompt 610 including selectable user interface elements such as no button 615 and yes button 620. A user may select the no button 615 and the road hazard information may continue to be transmitted (e.g., as described in FIG. 3) or the yes button 620 and the road hazard information may no longer be transmitted (or the transmission may be modified, etc.).

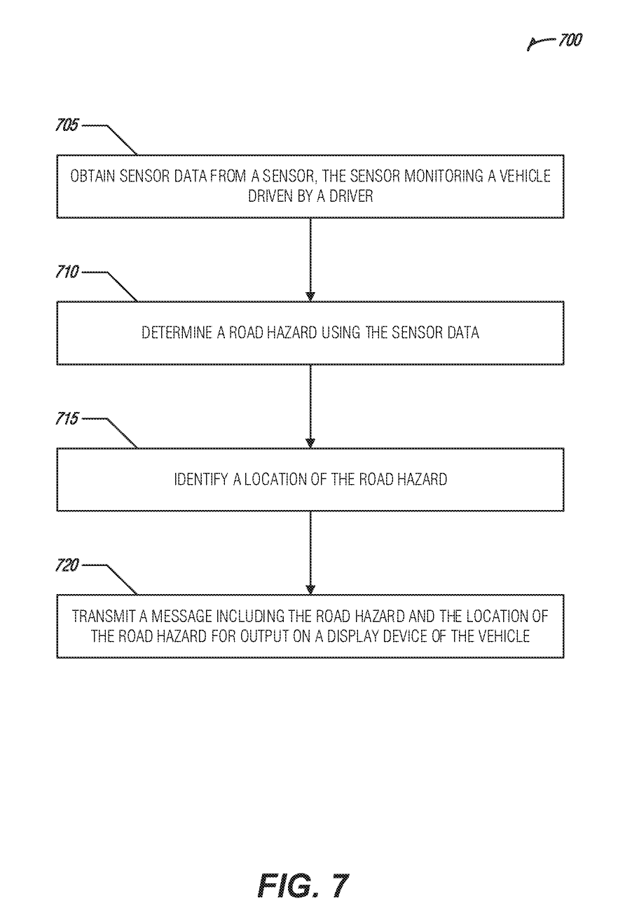

FIG. 7 illustrates an example of a method 700 for sensor-derived road hazard detection and reporting, according to an embodiment. The method 700 may provide functionality as described in FIGS. 1-6.

At operation 705, sensor data may he obtained from a sensor. The sensor may monitor a vehicle driven by a driver. In an example, the sensor may be a camera. In an example, the sensor may be a depth sensor. In an example, the sensor may be a radio frequency identification receiver. In an example, the sensor may be a computer of a vehicle.

At operation 710, a road hazard may be determined using the sensor data. In an example, a first image including an item traveling with the vehicle may be obtained from the sensor data. A second image of an area around the vehicle may be obtained from the sensor. The second image may be analyzed to determine that the item is no longer traveling with the vehicle. The road hazard may be determined based on the determination that the item is no longer traveling with the vehicle.

In an example, a measurement between an object traveling with the vehicle and the sensor may be obtained from the sensor data. It may be determined that the measurement between the object traveling with the vehicle and the sensor has changed using the sensor data. The road hazard may be determined based on the determination that the measurement between the object traveling with the vehicle and the sensor has changed.

In an example, a presence of a radio frequency identifier corresponding to an item traveling with the vehicle may be identified using the sensor data. It may be determined that the presence of the radio frequency identifier corresponding to the item no longer exits using the sensor data. The road hazard may be determined based on the determination that the presence of the radio frequency identifier corresponding to the item no longer exists.

In an example, an image may be obtained from the sensor data. The image may include a pavement surface.: presence of a foreign object may be identified on the pavement surface by analyzing the image. The road hazard may be determined based on the presence of the foreign object on the pavement surface.

In an example, a set of vehicle measurements may be obtained from the sensor data. It may be identified that the set of vehicle operation measurements are outside an expected range. The road hazard may be determined based on the identification that the set of vehicle operation measurements are outside the expected range.

At operation 715, a location of the road hazard may be identified. In an example, a time of detection may be identified for the road hazard. Geolocation data may be obtained for the vehicle at the time of detection using a global positioning receiver. The road hazard may be geotagged using the geolocation data.

At operation 720, a message may be transmitted, for output to a display device, the message may include the road hazard and the location of the road hazard. In an example, a message including the road hazard and the location of the road hazard may be transmitted to a cloud-based service. The message including the road hazard and the location of the road hazard may be output to a subscriber of the cloud-based service.

In an example, an image of the location of the road hazard may be obtained from a camera included in a vehicle of the subscriber. It may be identified that the road hazard no longer exists at the location of the road hazard using the image. The road hazard may be tagged as cleared based on the identification that the road hazard no longer exists at the location of the road hazard. The tag may prevent the message including the road hazard and the location of the road hazard from being output to other subscribers.

In an example, it may be identified that a collision has occurred near the location of the road hazard using data collected from a sensor array included with the vehicle of the subscriber. Information may be obtained about the driver. The information about the driver, the road hazard, and the location of the road hazard may be transmitted to a third party. In an example, a fine may be issued to the driver.

In an example, the message including the road hazard and the location of the road hazard may be presented to the driver in a user interface. A selectable user interface element may be displayed in the user interface that when selected indicates the road hazard has been cleared. The road hazard may be tagged as cleared upon selection of the selectable user interface element.

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set o multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit n the first circuit set, or by a third circuit in a second circuit set at a different time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet mobile telephone networks (e.g., cellular networks), Plain Old Telephone (POTS) networks, and wireless data networks (e.g., Institute of Electrical and. Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### ADDITIONAL NOTES & EXAMPLES

Example 1 is a system for tracking a source and location of a road hazard, the system comprising: at least one processor; and a memory including instructions that, when executed by the at least one processor, cause the at least one processor to: obtain sensor data from a sensor, wherein the sensor monitors a vehicle driven by a driver; determine a road hazard using the sensor data; identify a location of the road hazard; and transmit, for output on a display device of the vehicle, a message including the road hazard and location of the road hazard.

In Example 2, the subject matter of Example 1 optionally includes the instructions to determine the road hazard using the sensor data further comprising instructions to: obtain a first image including an item traveling with the vehicle from the sensor data; obtain a second image of an area around the vehicle from the sensor; analyze the second image to determine that the item is no longer traveling with the vehicle; and determine the road hazard based on the determination that the item is no longer traveling with the vehicle.

In Example 3, the subject matter of any one or more of Examples 1-2 optionally include the instructions to determine the road hazard using the sensor data further comprising instructions to: obtain a measurement between an object traveling with the vehicle and the sensor from the sensor data; determine that the measurement between the object traveling with the vehicle and the sensor has changed using the sensor data; and determine the road hazard based on the determination that the measurement between the object traveling with the vehicle and the sensor has changed.

In Example 4, the subject matter of any one or more of Examples 1-3 optionally include the instructions to determine the road hazard using the sensor data further comprising instructions to: identify a presence of a radio frequency identifier corresponding to an item traveling with the vehicle using the sensor data; determine that the presence of the radio frequency identifier corresponding to the item no longer exists using the sensor data; and determine the road hazard based on the determination that the presence of the radio frequency identifier corresponding to the item no longer exists.

In Example 5, the subject matter of any one or more of Examples 1-4 optionally include the instructions to determine the road hazard using the sensor data further comprising instructions to: obtain an image from the sensor data, the image including a pavement surface; identify a presence of a foreign object on the pavement surface by analyzing the image; and determine the road hazard based on the presence of the foreign object on the pavement surface.

In Example 6, the subject matter of any one or more of Examples 1-5 optionally include the instructions to determine the road hazard using the sensor data further comprising instructions to: obtain a set of vehicle operation measurements from the sensor data; identify that the set of vehicle operation measurements are outside an expected range; and determine the road hazard based on the identification that the set of vehicle operation measurements are outside the expected range.

In Example 7, the subject matter of any one or more of Examples 1-6 optionally include the instructions to identify the location of the road hazard further comprising instructions to: identify a time of detection for the road hazard; obtain geolocation data for the vehicle at the time of detection using a global positioning receiver; and geotag the road hazard using the geolocation data.

In Example 8, the subject matter of any one or more of Examples 1-7 optionally include instructions to: transmit a message including the road hazard and the location of the road hazard to a cloud-based service; and output the message including the road hazard and the location of the road hazard to a subscriber of the cloud-based service.

In Example 9, the subject matter of Example 8 optionally includes instructions to: obtain an image of the location of the road hazard from a camera included in a vehicle of the subscriber; identify the road hazard no longer exists at the location of the road hazard using the image; and tag the road hazard as cleared based on the identification that the road hazard no longer exists at the location of the road hazard, the tagging preventing the message including the road hazard and the location of the road hazard from being output to other subscribers.

In Example 10, the subject matter of any one or more of Examples 8-9 optionally include instructions to: identify that a collision has occurred near the location of the road hazard using data collected from a sensor array included with a vehicle of the subscriber; obtain information about the driver; and transmit the information about the driver, the road hazard, and the location of the road hazard to a third party.

In Example 11, the subject matter of any one or more of Examples 1-10 optionally include instructions to transmit the message including the road hazard and location of the road hazard to an authority responsible for the location of the road hazard.

In Example 12, the subject matter of any one or more of Examples 1-11 optionally include instructions to issue a fine to the driver.

In Example 13, the subject matter of any one or more of Examples 1-12 optionally include instructions to: present the message including the road hazard and location of the road hazard to the driver in a user interface; display, in the user interface, a selectable user interface element, that when selected, indicates the road hazard has been cleared; and tag, upon selection of the selectable user interface element, the road hazard as cleared.

In Example 14, the subject matter of any one or more of Examples 1-13 optionally include wherein the sensor is a camera.

In Example 15, the subject matter of any one or more of Examples 1-14 optionally include wherein the sensor is a depth sensor.

In Example 16, the subject matter of any one or more of Examples 1-15 optionally include wherein the sensor is a radio frequency identification receiver.

In Example 17, the subject matter of any one or more of Examples 1-16 optionally include wherein the sensor is a computer of the vehicle.

Example 18 is at least one computer readable medium including instructions for tracking a source and location of a road hazard that, when executed by a computer, cause the computer to: obtain sensor data from a sensor, wherein the sensor monitors a vehicle driven by a driver; determine a road hazard using the sensor data; identify a location of the road hazard; and transmit, for output on a display device of the vehicle, a message including the road hazard and location of the road hazard.

In Example 19, the subject matter of Example 18 optionally includes the instructions to determine the road hazard using the sensor data further comprising instructions to: obtain a first image including an item traveling with the vehicle from the sensor data; obtain a second image of an area around the vehicle from the sensor; analyze the second image to determine that the item is no longer traveling with the vehicle; and determine the road hazard based on the determination that the item is no longer traveling with the vehicle.

In Example 20, the subject matter of any one or more of Examples 18-19 optionally include the instructions to determine the road hazard using the sensor data further comprising instructions to: obtain a measurement between an object traveling with the vehicle and the sensor from the sensor data; determine that the measurement between the object traveling with the vehicle and the sensor has changed using the sensor data; and determine the road hazard based on the determination that the measurement between the object traveling with the vehicle and the sensor has changed.

In Example 21, the subject matter of any one or more of Examples 18-20 optionally include the instructions to determine the road hazard using the sensor data further comprising instructions to: identify a presence of a radio frequency identifier corresponding to an item traveling with the vehicle using the sensor data; determine that the presence of the radio frequency identifier corresponding to the item no longer exists using the sensor data; and determine the road hazard based on the determination that the presence of the radio frequency identifier corresponding to the item no longer exists.

In Example 22, the subject matter of any one or more of Examples 18-21 optionally include the instructions to determine the road hazard using the sensor data further comprising instructions to: obtain an image from the sensor data, the image including a pavement surface; identify a presence of a foreign object on the pavement surface by analyzing the image; and determine the road hazard based on the presence of the foreign object on the pavement surface.

In Example 23, the subject matter of any one or more of Examples 18-22 optionally include the instructions to determine the road hazard using the sensor data further comprising instructions to: obtain a set of vehicle operation measurements from the sensor data; identify that the set of vehicle operation measurements are outside an expected range; and determine the road hazard based on the identification that the set of vehicle operation measurements are outside the expected range.

In Example 24, the subject matter of any one or more of Examples 18-23 optionally include the instructions to identify the location of the road hazard further comprising instructions to: identify a time of detection for the road hazard; obtain geolocation data for the vehicle at the time of detection using a global positioning receiver; and geotag the road hazard using the geolocation data.

In Example 25, the subject matter of any one or more of Examples 18-24 optionally include instructions to: transmit a message including the road hazard and the location of the road hazard to a cloud-based service; and output the message including the road hazard and the location of the road hazard to a subscriber of the cloud-based service.

In Example 26, the subject matter of Example 25 optionally includes instructions to: obtain an image of the location of the road hazard from a camera included in a vehicle of the subscriber; identify the road hazard no longer exists at the location of the road hazard using the image; and tag the road hazard as cleared based on the identification that the road hazard no longer exists at the location of the road hazard, the tagging preventing the message including the road hazard and the location of the road hazard from being output to other subscribers.

In Example 27, the subject matter of any one or more of Examples 25-26 optionally include instructions to: identify that a collision has occurred near the location of the road hazard using data collected from a sensor array included with a vehicle of the subscriber; obtain information about the driver; and transmit the information about the driver, the road hazard, and the location of the road hazard to a third party.

In Example 28, the subject matter of any one or more of Examples 18-27 optionally include instructions to transmit the message including the road hazard and location of the road hazard to an authority responsible for the location of the road hazard.

In Example 29, the subject matter of any one or more of Examples 18-28 optionally include instructions to issue a fine to the driver.

In Example 30, the subject matter of any one or more of Examples 18-29 optionally include instructions to: present the message including the road hazard and location of the road hazard to the driver in a user interface; display, in the user interface, a selectable user interface element, that when selected, indicates the road hazard has been cleared; and tag, upon selection of the selectable user interface element, the road hazard as cleared.

In Example 31, the subject matter of any one or more of Examples 18-30 optionally include wherein the sensor is a camera.

In Example 32, the subject matter of any one or more of Examples 18-31 optionally include wherein the sensor is a depth sensor.

In Example 33, the subject matter of any one or more of Examples 18-32 optionally include wherein the sensor is a radio frequency identification receiver,

In Example 34, the subject matter of any one or more of Examples 18-33 optionally include wherein the sensor is a computer of the vehicle,

Example 35 is a method for tracking a source and location of a road hazard, the method comprising: obtaining sensor data from a sensor, the sensor monitoring a vehicle driven by a driver; determining a road hazard using the sensor data; identifying a location of the road hazard; and transmitting, for output on a display device of the vehicle, a message including the road hazard and location of the road hazard.

In Example 36, the subject matter of Example 35 optionally includes wherein determining the road hazard using the sensor data further comprises: obtaining a first image including an item traveling with the vehicle from the sensor data; obtaining a second image of an area around the vehicle from the sensor; analyzing the second image to determine that the item is no longer traveling with the vehicle; and determining the road hazard based on the determination that the item is no longer traveling with the vehicle.

In Example 37, the subject matter of any one or more of Examples 35-36 optionally include wherein determining the road hazard using the sensor data further comprises: obtaining a measurement between an object traveling with the vehicle and the sensor from the sensor data; determining that the measurement between the object traveling with the vehicle and the sensor has changed using the sensor data; and determining the road hazard based on the determination that the measurement between the object traveling with the vehicle and the sensor has changed.

In Example 38, the subject matter of any one or more of Examples 35-37 optionally include wherein determining the road hazard using the sensor data further comprises: identifying a presence of a radio frequency identifier corresponding to an item traveling with the vehicle using the sensor data; determining that the presence of the radio frequency identifier corresponding to the item no longer exists using the sensor data; and determining the road hazard based on the determination that the presence of the radio frequency identifier corresponding to the item no longer exists.

In Example 39, the subject matter of any one or more of Examples 35-38 optionally include wherein determining the road hazard using the sensor data further comprises: obtaining an image from the sensor data, the image including a pavement surface; identifying a presence of a foreign object on the pavement surface by analyzing the image; and determining the road hazard based on the presence of the foreign object on the pavement surface.

In Example 40, the subject matter of any one or more of Examples 35-39 optionally include wherein determining the road hazard using the sensor data further comprises: obtaining a set of vehicle operation measurements from the sensor data; identifying that the set of vehicle operation measurements are outside an expected range; and determining the road hazard based on the identification that the set of vehicle operation measurements are outside the expected range.

In Example 41, the subject matter of any one or more of Examples 35-40 optionally include wherein identifying the location of the road hazard further comprises: identifying a time of detection for the road hazard; obtaining geolocation data for the vehicle at the time of detection using a global positioning receiver; and geotagging the road hazard using the geolocation data.

In Example 42, the subject matter of any one or more of Examples 35-41 optionally include transmitting a message including the road hazard and the location of the road hazard to a cloud-based service; and outputting the message including the road hazard and the location of the road hazard to a subscriber of the cloud-based service.

In Example 43, the subject matter of Example 42 optionally includes obtaining an image of the location of the road hazard from a camera included in a vehicle of the subscriber; identifying the road hazard no longer exists at the location of the road hazard using the image; and tagging the road hazard as cleared based on the identification that the road hazard no longer exists at the location of the road hazard, the tagging preventing the message including the road hazard and the location of the road hazard from being output to other subscribers.

In Example 44, the subject matter of any one or more of Examples 42-43 optionally include identifying that a collision has occurred near the location of the road hazard using data collected from a sensor array included with a vehicle of the subscriber; obtaining information about the driver; and transmitting the information about the driver, the road hazard, and the location of the road hazard to a third party.

In Example 45, the subject matter of any one or more of Examples 35-44 optionally include transmitting the message including the road hazard and location of the road hazard to an authority responsible for the location of the road hazard.

In Example 46, the subject matter of any one or more of Examples 35-45 optionally include issuing a fine to the driver.

In Example 47, the subject matter of any one or more of Examples 35-46 optionally include presenting the message including the road hazard and location of the road hazard to the driver in a user interface; displaying, in the user interface, a selectable user interface element, that when selected, indicates the road hazard has been cleared; and tagging, upon selection of the selectable user interface element, the road hazard as cleared.

In Example 48, the subject matter of any one or more of Examples 35-47 optionally include wherein the sensor is a camera.

In Example 49, the subject matter of any one or more of Examples 35-48 optionally include wherein the sensor is a depth sensor.

In Example 50, the subject matter of any one or more of Examples 35-49 optionally include wherein the sensor is a radio frequency identification receiver.

In Example 51, the subject matter of any one or more of Examples 35-50 optionally include wherein the sensor is a computer of the vehicle.

Example 52 is a system to implement tracking a source and location of a road hazard, the system comprising means to perform any method of Examples 35-51,

Example 53 is at least one machine readable medium to implement tracking a source and location of a road hazard, the at least one machine readable medium including instructions that, when executed by a machine, cause the machine to perform any method of Examples 35-51.

Example 54 is a system for tracking a source and location of a road hazard, the system comprising: means for obtaining sensor data from a sensor, the sensor monitoring a vehicle driven by a driver; means for determining a road hazard using the sensor data; means for identifying a location of the road hazard; and means for transmitting, for output on a display device of the vehicle, a message including the road hazard and location of the road hazard.

In Example 55, the subject matter of Example 54 optionally includes wherein the means for determining the road hazard using the sensor data further comprises: means for obtaining a first image including an item traveling with the vehicle from the sensor data; means for obtaining a second image of an area around the vehicle from the sensor; means for analyzing the second image to determine that the item is no longer traveling with the vehicle; and means for determining the road hazard based on the determination that the item is no longer traveling with the vehicle.

In Example 56, the subject matter of any one or more of Examples 54-55 optionally include wherein the means for determining the road hazard using the sensor data further comprises: means for obtaining a measurement between an object traveling with the vehicle and the sensor from the sensor data; means for determining that the measurement between the object traveling with the vehicle and the sensor has changed using the sensor data; and means for determining the road hazard based on the determination that the measurement between the object traveling with the vehicle and the sensor has changed.

In Example 57, the subject matter of any one or more of Examples 54-56 optionally include wherein the means for determining the road hazard using the sensor data further comprises: means for identifying a presence of a radio frequency identifier corresponding to an item traveling with the vehicle using the sensor data; means for determining that the presence of the radio frequency identifier corresponding to the item no longer exists using the sensor data; and means for determining the road hazard based on the determination that the presence of the radio frequency identifier corresponding to the item no longer exists.

In Example 58, the subject matter of any one or more of Examples 54-57 optionally include wherein the means for determining the road hazard using the sensor data further comprises: means for obtaining an image from the sensor data, the image including a pavement surface; means for identifying a presence of a foreign object on the pavement surface by analyzing the image; and means for determining the road hazard based on the presence of the foreign object on the pavement surface.

In Example 59, the subject matter of any one or more of Examples 54-58 optionally include wherein the means for determining the road hazard using the sensor data further comprises: means for obtaining a set of vehicle operation measurements from the sensor data; means for identifying that the set of vehicle operation measurements are outside an expected range; and means for determining the road hazard based on the identification that the set of vehicle operation measurements are outside the expected range.

In Example 60, the subject matter of any one or more of Examples 54-59 optionally include wherein the means for identifying the location of the road hazard further comprises: means for identifying a time of detection for the road hazard; means for obtaining geolocation data for the vehicle at the time of detection using a global positioning receiver; and means for geotagging the road hazard using the geolocation data.

In Example 61, the subject matter of any one or more of Examples 54-60 optionally include means for transmitting a message including the road hazard and the location of the road hazard to a cloud-based service; and means for outputting the message including the road hazard and the location of the road hazard to a subscriber of the cloud-based service.

In Example 62, the subject matter of Example 61 optionally includes means for obtaining an image of the location of the road hazard from a camera included in a vehicle of the subscriber; means for identifying the road hazard no longer exists at the location of the road hazard using the image; and means for tagging the road hazard as cleared based on the identification that the road hazard no longer exists at the location of the road hazard, the tagging preventing the message including the road hazard and the location of the road hazard from being output to other subscribers.

In Example 63, the subject matter of any one or more of Examples 61-62 optionally include means for identifying that a collision has occurred near the location of the road hazard using data collected from a sensor array included with a vehicle of the subscriber; means for obtaining information about the driver; and means for transmitting the information about the driver, the road hazard, and the location of the road hazard to a third party.

In Example 64, the subject matter of any one or more of Examples 54-63 optionally include means for transmitting the message including the road hazard and location of the road hazard to an authority responsible for the location of the road hazard.

In Example 65, the subject matter of any one or more of Examples 54-64 optionally include means for issuing a fine to the driver.

In Example 66, the subject matter of any one or more of Examples 54-65 optionally include means for presenting the message including the road hazard and location of the road hazard to the driver in a user interface; means for displaying, in the user interface, a selectable user interface element, that when selected, indicates the road hazard has been cleared; and means for tagging, upon selection of the selectable user interface element, the road hazard as cleared.

In Example 67, the subject matter of any one or more of Examples 54-66 optionally include wherein the sensor is a camera.

In Example 68, the subject matter of any one or more of Examples 54-67 optionally include wherein the sensor is a depth sensor.

In Example 69, the subject matter of any one or more of Examples 54-68 optionally include wherein the sensor is a radio frequency identification receiver.

In Example 70, the subject matter of any one or more of Examples 54-69 optionally include wherein the sensor is a computer of the vehicle.

Example 71 is at least one machine-readable medium including instructions, which when executed by a machine, cause the machine to perform operations of any of the operations of Examples 1-70.

Example 72 is an apparatus comprising means for performing any of the operations of Examples 1-70.

Example 73 is a system to perform the operations of any of the Examples 1-70.

Example 74 is a method to perform the operations of any of the Examples 1-70.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A system for tracking a source and location of a road hazard, the system comprising:
at least one processor; and
machine readable media including instructions that, when executed by the at least one processor, cause the at least one processor to:
obtain sensor data from a sensor, wherein the sensor monitors a vehicle driven by a driver;
determine a road hazard using the sensor data;
identify a location of the road hazard; and
transmit, for output on a display device of the vehicle, a message including the road and location of the road hazard.

2. The system of claim 1, the instructions to determine the road hazard using the sensor data further comprising instructions to:
obtain a first image including an item traveling with the vehicle from the sensor data;
obtain a second image of an area around the vehicle from the sensor;
analyze the second image to determine that the item is no longer traveling with the vehicle; and
determine road hazard based on the determination that the item is no longer traveling the vehicle.

3. The system of claim 1, the instructions to determine the road hazard using the sensor data further comprising instructions to:
obtain a measurement between an object traveling with the vehicle and the sensor from the sensor data;
determine that the measurement between the object traveling with the vehicle and the sensor has changed using the sensor data; and
determine the road hazard based on the determination that the measurement between the object traveling with the vehicle and the sensor has changed.

4. The system of claim 1, the instructions to determine the road hazard using the sensor data further comprising instructions to:
identify a presence of a radio frequency identifier corresponding to an item traveling with the vehicle using the sensor data;
determine that the presence of the radio frequency identifier corresponding to the item no longer exists using the sensor data; and
determine the road hazard based on the determination that the presence of the radio frequency identifier corresponding to the item no longer exists.

5. The system of claim 1, the instructions to determine the road hazard using the sensor data further comprising instructions to:
obtain an image from the sensor data, the image including a pavement surface;
identify a presence of a foreign object on the pavement surface by analyzing the image; and
determine the road hazard based on the presence of the foreign object on the pavement surface.

6. The system of claim 1, the instructions to determine the road hazard using the sensor data further comprising instructions to:
obtain a set of vehicle operation measurements from the sensor data;
identify that the set of vehicle operation measurements are outside an expected range; and
determine the road hazard based on the identification that the set of vehicle operation measurements are outside the expected range.

7. The system of claim 1, the instructions to identify the location of the road hazard further comprising instructions to:
identify a time of detection for the road hazard;
obtain geolocation data for the vehicle at the time of detection using a global positioning receiver; and
geotag the road hazard using the geolocation data.

8. The system of claim 1, further comprising instructions to:
transmit a message including the road hazard and the location of the road hazard to a cloud-based service; and
output the message including the road hazard and the location of the road hazard to a subscriber of the cloud-based service.

9. The system of claim 8, further comprising instructions to:
obtain an image of the location of the road hazard from a camera included in a vehicle of the subscriber;
identify the road hazard no longer exists at the location of the road hazard using the image; and
tag the road hazard as cleared based on the identification that the road hazard no longer exists at the location of the road hazard, the tagging preventing the message including the road hazard and the location of the road hazard from being output to other subscribers.

10. The system of claim 8, further comprising instructions to:
identify that a collision has occurred near the location of the road hazard using data collected from a sensor array included with a vehicle of the subscriber;
obtain information about the driver; and
transmit the information about the driver, the road hazard, and the location of the road hazard to a third party.

11. The system of claim 1, further comprising instructions to:
present the message including the road hazard and location of the road hazard to the driver in a user interface;
display, in the user interface, a selectable user interface element, that when selected, indicates the road hazard has been cleared; and
tag, upon selection of the selectable user interface element, the road hazard as cleared.

12. At least one computer readable medium including instructions for tracking a source and location of a road hazard that, when executed by a computer, cause the computer to:
obtain sensor data from a sensor, wherein the sensor monitors a vehicle driven by a driver;
determine a road hazard using the sensor data;
identify a location of the road hazard; and
transmit, for output on a display device of the vehicle, a message including the road and location of the road hazard.

13. The at least one computer readable medium of claim 12, the instructions to determine the road hazard using the sensor data further comprising instructions to:
obtain a first image including an item traveling with the vehicle from the sensor data;
obtain a second image of an area around the vehicle from the sensor;
analyze the second image to determine that the item is no longer traveling wide the vehicle; and
determine the road hazard based on the determination that the item is no longer traveling with the vehicle.

14. The at least one computer readable medium of claim 12, the instructions to determine the road hazard using the sensor data further comprising instructions to:
obtain a measurement between an object traveling with the vehicle and the sensor from the sensor data;
determine that the measurement between the object traveling with the vehicle and the sensor has changed using the sensor data; and
determine the road hazard based on the determination that the measurement between the object traveling with the vehicle and the sensor has changed.

15. The at least one computer readable medium of claim 12, the instructions to determine the road hazard using the sensor data further comprising instructions to:
obtain an image from the sensor data, the image including a pavement surface;
identify a presence of a foreign object on the pavement surface by analyzing the image; and
determine the road hazard based on the presence of the foreign object on the pavement surface.

16. The at least one computer readable medium of claim 12, further comprising instructions to:
transmit a message including the road hazard and the location of the road hazard to a cloud-based service; and
output the message including the road hazard and the location of the road hazard to a subscriber of the cloud-based service.

17. The at least one computer readable medium of claim 16, further comprising instructions to:
obtain an image of the location of the road hazard from a camera included in a vehicle of the subscriber;
identify the road hazard no longer exists at the location of the road hazard using the image: and
tag the road hazard as cleared based on the identification that the road hazard no longer exists at the location of the road hazard, the tagging preventing the message including the road hazard and the location of the road hazard from being output to other subscribers.

18. The at least one computer readable medium of claim 16, further comprising instructions to:
identify that a collision has occurred near the location of the road hazard using data collected from a sensor array included with a vehicle of the subscriber;
obtain information about the driver; and
transmit the information about the driver, the road hazard, and the location of the road hazard to a third party.

19. A method for tracking a source and location of a road hazard, the method comprising:
obtaining sensor data from a sensor, the sensor monitoring a vehicle driven by a driver;
determining a road hazard using the sensor data;
identifying a location of the road hazard; and
transmitting, for output on a display device of the vehicle, a message including the road hazard and location of the road hazard.

20. The method of claim 19, wherein determining the road hazard using the sensor data further comprises:
obtaining a first image including an item traveling with the vehicle from the sensor data;
obtaining a second image of an area around the vehicle from the sensor;
analyzing the second image to determine that the item is no longer traveling with vehicle; and
determining the road hazard based on the determination that the item is no longer traveling with the vehicle.

21. The method of claim 19, wherein determining the road hazard using the sensor data further comprises:
obtaining a measurement between an object traveling with vehicle and the sensor from the sensor data;
determining that the measurement between the object traveling with the vehicle and the sensor has changed using the sensor data; and
determining the road hazard based on the determination that the measurement between object traveling with the vehicle and the sensor has changed.

22. The method of claim 19, further comprising:
transmitting a message including the road hazard and the location of the road hazard to a cloud-based service; and
outputting the message including the road hazard and the location of the road hazard to a subscriber of the cloud-based service.

23. The method of claim 22, further comprising:
obtaining an image of the location of the road hazard from a camera included in a vehicle of the subscriber;
identifying the road hazard no longer exists at the location of the road hazard rising the image; and
tagging the road hazard as cleared based on the identification that the road hazard no longer exists at the location of the road hazard, the tagging preventing the message including the road hazard and the location of the road hazard from being output to other subscribers.

24. The method of claim 22, further comprising:
identifying that a collision has occurred near the location of the road hazard using data collected from a sensor array included with a vehicle of the subscriber;
obtaining information about the driver; and
transmitting the information about the driver, the road and the location of the road hazard to a third party.
